(19) United States
(12) Patent Application Publication
(10) Pub. No.: US 2019/0308679 A1
(43) Pub. Date: Oct. 10, 2019

(54) OVERHEAD CONVEYOR FOR CONVEYING HEAVY LOADS

(71) Applicant: EISENMANN SE, Böblingen (DE)

(72) Inventors: Ulrich Hofbauer, Gäufelden (DE); Alexander Schurba, Sindelfingen (DE)

(21) Appl. No.: 16/467,565

(22) PCT Filed: Dec. 1, 2017
(86) PCT No.: PCT/EP2017/081271

§ 371 Date: Jun. 7, 2019

(30) Foreign Application Priority Data
Dec. 8, 2016 (DE) 10 2016 123 863.5

(51) Int. Cl. B62D 65/18; B61B 3/02; B65G 9/00; E01B 25/24; B61C 13/04; B65G 1/04

(52) U.S. Cl. CPC B62D 65/18; B61B 3/02; B65G 9/002; B65G 1/0457; E01B 25/24; B61C 13/04; B65G 9/008

(57) ABSTRACT

An overhead conveyor for conveying heavy loads such as lorry frame components, lorry trailers or the like, the overhead conveyor having passive travelling mechanisms guided on rails for receiving the heavy load, wherein at least two passive travelling mechanisms are connected via a load-bearing crossmember to form a passive carrier, and the load-bearing crossmember is designed to receive the heavy load, extends substantially along the conveying direction, and is mounted underneath the passive travelling mechanism, and at least one stationary drive device for introducing a driving force into the passive carrier, wherein the drive device has a friction wheel-counter wheel arrangement and a contact device, the friction wheel being mounted on one side of the load-bearing crossmember in order to transmit the driving force to the load-bearing crossmember, and the counter wheel being mounted, transverse to the conveying direction, on the side of the load-bearing crossmember opposite said first side in order to transmit a transverse force to the load-bearing crossmember and/or to absorb a transverse force from the load-bearing crossmember, wherein a contact force is exerted by means of the contact device via the counter wheel and/or via the friction wheel in the direction of the load-bearing crossmember. The drive device has a preloading device designed to apply an additional preloading force to the contact device.

### BACKGROUND OF THE INVENTION

### 1. Field of the Invention

The present invention relates to an overhead conveyor for conveying heavy loads such as, for example, truck frame components, truck trailers or the like. Such an overhead conveyor exhibits passive running mechanisms, guided on rails, for receiving a heavy load. At least two passive running mechanisms have been connected via a load cross-member to form a passive cart. The load cross-member is designed to receive a heavy load, extends substantially along the conveying direction, and is attached below the passive running mechanisms. The overhead conveyor further exhibits at least one stationary drive device for introducing a propelling force onto the passive cart. The drive device exhibits a friction-gear/mating-gear arrangement and also a contact-pressure appliance. For the purpose of transmitting the propelling forces to the load cross-member, the friction gear is arranged on one side of the load cross-member. For the purpose of transmitting and/or receiving a transverse force transmitted to the load cross-member at right angles to the conveying direction, the mating gear is arranged on a side situated opposite the first side of the load cross-member. By means of the contact-pressure appliance, a contact force is exerted in the direction of the load cross-member via the mating gear and/or via the friction gear.

### 2. Description of the Prior Art

The transportation of heavy loads—such as, for instance, those mentioned above—with such an overhead conveyor makes high demands on the components of the conveyor structure. By reason of the high weight of the loads to be conveyed, and the necessity for thermal treatment, the drive devices along the conveying path are stationary and output propelling forces to the passive running mechanisms, in particular to the load cross-members, via friction gears. In the course of a transfer of a load cross-member from one drive unit to the next drive unit, it cannot be ensured without major effort that the drive units are running at the same speed and consequently are transmitting the same propelling forces to the load cross-member. In order to avoid an impact force between drive unit and cart train in the course of the transfer from one drive unit to a further drive unit, ordinarily low transportation speeds or elaborate electrical control systems are employed for the purpose of synchronization.

Further disadvantages result from the fact that the load cross-members are regularly exposed to thermal treatments and, by reason of the associated fluctuations in temperature, exhibit high tolerances with regard to their outside dimensions. A further factor is that the friction-gear/mating-gear arrangement is subjected to wear which, for instance, results in a reduction of the outside diameter of the friction gear or of the mating gear. This also contributes to the fact that, in operation, the precise relative position between the outside of the cross-member and the friction-gear/mating-gear arrangement interacting therewith is not known exactly, and consequently the propelling forces to be transmitted to the load cross-member are subject to just such a fluctuation.

This further aggravates, in particular, the transfer process between two different drive units.

### SUMMARY OF THE INVENTION

It is an object of the invention to specify an overhead conveyor for conveying heavy loads such as truck bodies of the aforementioned type, in which a passive running mechanism can be carried out from one drive device to a further drive device while avoiding large impact forces and a concomitant major wear. The corresponding overhead conveyor should have a simple structural design that offers high stability and reliability.

The invention is achieved by an overhead conveyor according to the independent claim, claim 1. Further configurations of the invention are specified in the dependent claims.

The overhead conveyor according to the invention for conveying heavy loads such as truck frame components, truck trailers or the like comprises passive running mechanisms, guided on rails, for receiving the heavy load, in which connection at least two passive running mechanisms have been connected via a load cross-member to form a passive cart, and the load cross-member is designed to receive the heavy load, extends substantially along the conveying direction, is attached below the passive running mechanisms, and at least one stationary drive device for introducing a propelling force on the passive cart, in which connection the drive device exhibits a friction-gear/mating-gear arrangement and also a contact-pressure appliance, in which connection for the purpose of transmitting the propelling forces to the load cross-member the friction gear is arranged on one side of the load cross-member, and for the purpose of transmitting and/or receiving a transverse force transmitted to the load cross-member at right angles to the conveying direction the mating gear is arranged on a side situated opposite the first side of the load cross-member, in which connection a contact force is exerted in the direction of the load cross-member by means of the contact-pressure appliance via the mating gear and/or via the friction gear.

In accordance with the invention there is provision that the drive device exhibits a prestressing device which is designed to impose an additional prestressing force on the contact-pressure appliance. By means of the additional prestressing device, the propelling force exerted by the friction-gear/mating-gear arrangement on the load cross-member can consequently be set in straightforward manner and, in particular, kept constant. For instance, the aforementioned wear effects can be compensated by an increase or decrease of the prestressing force. The same applies to a compensation of the high tolerances that a load cross-member may exhibit along the conveying direction.

According to an advantageous embodiment, the prestressing device is capable of being triggered via hydraulic, electrical and/or pneumatic means. Depending upon the configuration of the overall plant, one or another means can preferably be employed. A factor that is common to the means is a capacity for remote control of the prestressing device. This is accompanied at the same time by a certain capacity for automation of the prestressing device.

Accordingly, in one embodiment there is provision that the prestressing device has been set up to compensate for a variable spacing between the load cross-member and the friction gear. The compensation of the variable spacing can be undertaken, for instance, during a passage of the cross-member along the friction-gear/mating-gear arrangement. This means that such a triggering of the prestressing device can take place during the conveying process. Consequently a slippage occurring during a conveying process, for instance, can be countered, for instance by the prestressing device exerting a greater force.

Alternatively or additionally, an adaptation taking place over a longer time-scale can be carried out, in order, for instance, to counter ascertained or predicted wear effects.

In one embodiment there is provision that the prestressing force imposed on the contact-pressure appliance has a component that acts in the direction of the contact force. Consequently the contact force exerted by the friction-gear/mating-gear arrangement on the load cross-member—and hence, indirectly, the propelling force exerted by the friction gear on the load cross-member—can be controlled or regulated in a straightforward manner.

In one embodiment there is advantageously provision that the relative position of load cross-member and stationary drive device and/or the relative speed between drive device and load cross-member can be detected by a sensor. A sensor signal that is generated in this way can be used for the triggering of the prestressing device, in particular for the purpose of adapting the prestressing force and hence, indirectly, the propelling force transmitted to the load cross-member via the friction gear.

In one embodiment there is provision that the prestressing device is mounted so as to be fixed relative to the contact-pressure appliance. Whereas the contact-pressure appliance exerts a contact force on the friction gear and/or on the mating gear in the direction of the load cross-member, and consequently at least a part of the contact-pressure appliance jointly executes a motion exerted by the mating gear and/or by the friction gear, for instance a swiveling motion in the direction of the load cross-member, the prestressing device may have been mounted so as to be fixed and may, for instance, be supported on the drive device.

In an exemplary embodiment, the prestressing device may include an eccentric. The eccentric serves for converting a rotational motion into a linear translational motion and may, for instance, comprise a control disk attached to a shaft, the point of rotation of which lies outside the axis of the shaft.

In an advantageous embodiment, the mating gear is mounted so as to be capable of swiveling about a mating-gear swivel axis, said mating-gear swivel axis being oriented perpendicular to the extent of the load cross-member. The mating gear can accordingly be swiveled about the mating-gear swivel axis in the direction of the load cross-member and can, where appropriate, exert a variable force on the load cross-member via the contact-pressure appliance.

In one embodiment there may particularly advantageously be provision that the contact-pressure appliance is mounted so as to be capable of swiveling about a contact-pressure-appliance swivel axis, said contact-pressure-appliance swivel axis and said mating-gear swivel axis extending through a common point of rotation and preferentially parallel to one another. This has the result that the direction of the force introduced onto the mating gear via the contact-pressure appliance does not change in the course of a swiveling of the mating gear.

In one embodiment there is provision that the friction gear exhibits a friction-gear axis, and the drive device introduces a force onto the load cross-member substantially perpendicular to a longitudinal orientation of the load cross-member and substantially perpendicular to the friction-gear axis. This arrangement guarantees an optimal introduction of the propelling force exerted by the friction gear on the load cross-member.

Advantageously, at least two drive devices are provided in an overhead conveyor, the spacing between the two drive devices corresponding at most to the length of a load cross-member. Accordingly, in normal operation at least one drive device—in the course of a transfer of the passive cart from one drive device to the other drive device, also briefly two drive devices—bear(s) against the load cross-member.

### BRIEF DESCRIPTION OF THE DRAWINGS

Examples of embodiments of the invention will be elucidated in more detail in the following with reference to the drawings. Shown therein are:

FIG. 1 an embodiment, according to the invention, of an overhead conveyor in a side view represented schematically;

FIG. 2 a sectional view along line A-A in FIG. 1;

FIG. 3 a sectional view along line B-B in FIG. 2 in an active state;

FIG. 4 the sectional view of FIG. 3 in a passive state;

FIG. 5 the overhead conveyor of FIG. 1 in the course of a transfer of a cart train from one friction-gear drive to the next friction-gear drive; and

FIG. 6 the overhead conveyor of FIG. 1 in the course of a transfer of a workpiece from a telescopic conveyor to the friction-gear drive.

### DESCRIPTION OF PREFERRED EMBODIMENT EXAMPLES

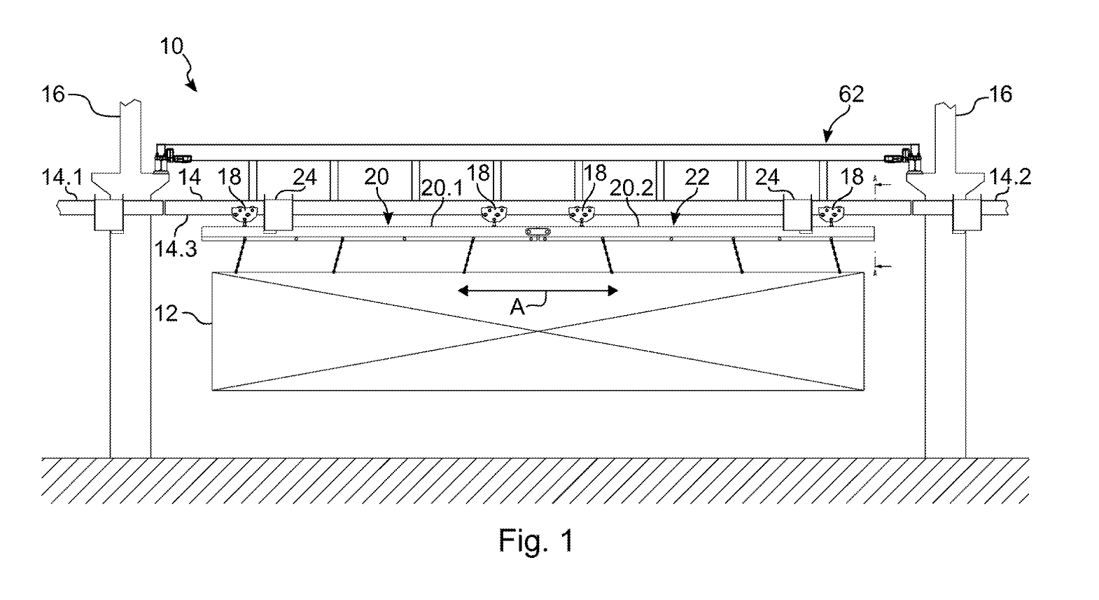

FIG. 1 shows an embodiment of an overhead conveyor 10. The overhead conveyor 10 is designed for conveying heavy loads such as truck frame components, truck trailers or the like. In FIG. 1, such a heavy load is represented symbolically and provided with reference symbol 12. The overhead conveyor 10 exhibits a carrier rail 14 which are attached to an elevated steel structure 16 (only partially represented). In the embodiment shown in FIG. 1, the carrier rail is tripartite. Whereas a first part 14.1 and a second part 14.2 are stationary—that is to say, immovably attached—a third part 14.3 is attached so as to be capable of being traversed perpendicular to the plane of the drawing on a traversing bridge.

In FIG. 1 a total of four passive running mechanisms 18, which have been connected via a load cross-member 20 to form a passive cart or cart train 22, are running on the carrier rails 14. The load cross-member 20 is designed to receive the heavy load, extends substantially along the conveying direction A, and is attached in suspended manner below the passive running mechanisms 18. In the present embodiment example, said load cross-member is structurally bipartite. The two parts 20.1, 20.2 have been connected to one another in articulated manner, in order to make correspondingly smaller radii possible in the case of ascending or curved sections. Of course, one-part or multi-part load cross-members may also be realized without departing from the subject-matter of the present invention.

Likewise attached to the carrier rail 14 are two stationary drive devices 24. These serve for introducing a propelling force onto the passive cart 22, in particular onto the load cross-member 20 thereof.

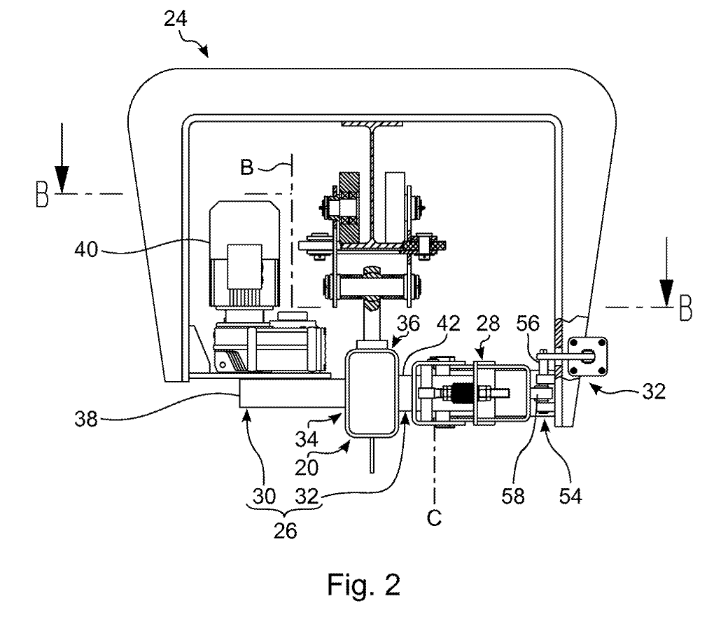

FIG. 2 shows a sectional view along line A-A in FIG. 1 and serves for better illustration of the drive device 24. The drive device 24 exhibits a friction-gear/mating-gear arrangement 26, also designated as a friction-gear drive, and also a contact-pressure appliance 28. The friction-gear/mating-gear arrangement 26 comprises a friction gear 30 and also a mating gear 32. The friction gear 30 serves for transmitting propelling forces to the load cross-member 20, in particular to a first side 34 of the load cross-member 20. The mating gear 32 serves for transmitting a transverse force to the load cross-member 20, in order to generate a sufficiently high frictional force between the load cross-member 20 and the friction gear 30. The mating gear 32 contacts a side 36 situated opposite the first side 34.

The friction gear 30 exhibits a driving roller 38 which is driven via an electric motor 40—where appropriate, coupled via a transmission—and is mounted so as to be capable of rotating about a rotation axis B. In the present embodiment, the rotation axis B of the driving roller 38 is mounted so as to be fixed relative to the carrier rail 14 and is not designed to execute linear-translational or rotational motions.

The mating gear 32 exhibits a running roller 42 which is not driven and, received on a rotary bearing 33, is mounted so as to be capable of rotating about a rotation axis C. The rotary bearing 33 itself is mounted on a contact-pressure appliance 45 including a swivel arm 44. The swivel arm 44 is capable of swiveling about a rotation axis D. At the end of the swivel arm 44 situated opposite rotation axis D, a receiving point 46 is provided for receiving a contact force that is capable of being transmitted via a contact-pressure arm 48 to the receiving point 46 and hence to the swivel arm 44.

The contact-pressure arm 48 is capable of swiveling about the same rotation axis D and exhibits at its end situated opposite the point of rotation D a contact-pressure spring 50 which serves for transmitting the contact force to the swivel arm 44.

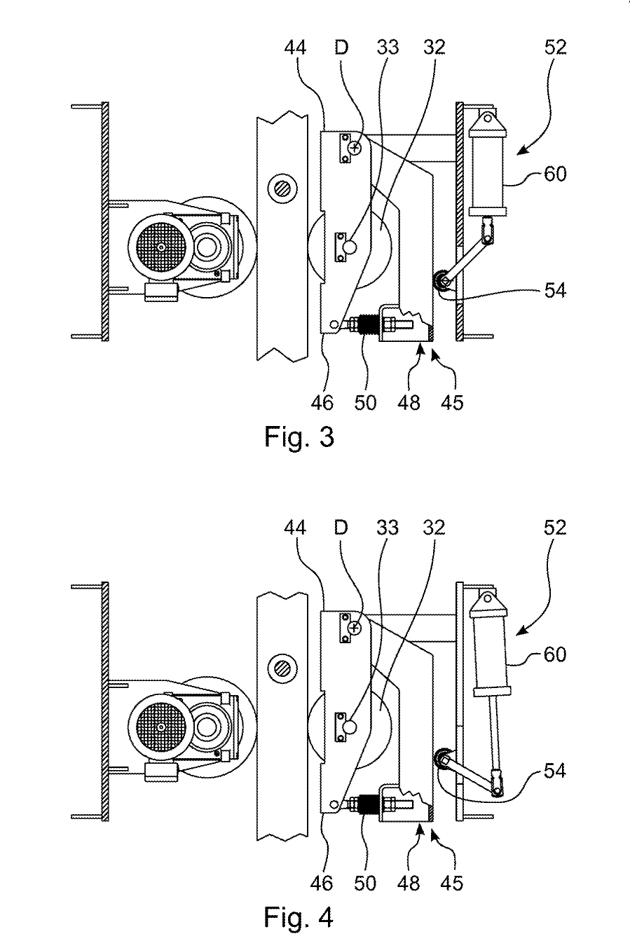

The swivel range of the contact-pressure arm 48 is such that the swivel range evident in FIG. 3 is limited counterclockwise in such a way that a transmission of a contact force to the swivel arm 44 is always possible.

A prestressing force can, in turn, imposed on the contact-pressure arm 48 itself via a displacement device or prestressing device 52 which is supported on the carrier rail 14. The displacement device 52 exhibits an eccentric 54 transmitting the prestressing force to the contact-pressure arm 48.

The implementation of the element transmitting the prestressing force as an eccentric 54 has been represented here as preferred, but is not to be understood as limiting. Other implementations are also possible. For instance, the transmission can also be undertaken via a direct linear motion or via a swiveling motion. Alternatively or additionally, the force could also be applied or introduced in the contact-pressure arm 48 itself via a rotational motion.

The eccentric 54 in the present case is implemented as a control disk 58 mounted on a shaft 56. The point of rotation of the control disk 58 is located outside the axis of the shaft 56 and in this way permits a change of the contact force of the contact-pressure arm 48, which the latter transmits to the swivel arm 44, by an additive superimposition of the prestressing force introduced onto the swivel arm 44 by the control disk 58.

The level of the prestressing force can be chosen via the position of the control disk 58 and is triggered via an adjusting appliance 60 which may operate, for instance, electrically, hydraulically or pneumatically. FIG. 3 shows a position in which a maximum prestressing force is transmitted to the contact-pressure arm 44 by means of the control disk 58.

FIG. 4, on the other hand, shows a position in which the control disk has no contact with the contact-pressure arm 44 and consequently does not superimpose a prestressing force on the contact force.

The displacement device 52 accordingly makes it possible to control the level of the contact force transmitted by the contact-pressure arm 48 to the swivel arm 44, and hence indirectly to the passive running roller 42, via an adjusting member—here the displacement device 52. In this case, the embodiment represented here represents a realization of the inventive basic idea that is particularly easy to realize and safe. Even in the event of a failure of the adjusting appliance 60, the friction-gear drive can continue to be operated without malfunction. At the same time, the constructional effort is extremely low and can even be retrofitted in straightforward manner.

In the embodiment example described above, the running roller 42 and the driving roller 38 can in principle be interchanged—that is to say, the driving roller 38 may have been movably suspended, and the running roller may have been rigidly attached.

During the operation of the overhead conveyor 10 the displacement device 52 can be employed in various ways. In a simple application scenario, the reducing diameter and the thereby reducing contact force are compensated by an increase of the prestressing force via a simple ascertainment of the abrasion or of some other wear of the driving roller 38 or of the running roller 42. This can be undertaken, independently of the actual mode, in continuously readjusting manner or at regular intervals in stepwise adapting manner.

Alternatively or additionally, there may be provision to superimpose the prestressing force on the contact force for the purpose of compensating for any existing dimensional tolerances, for instance of the load cross-member 20. This can, for instance, be done in anticipation, so to speak, by reason of dimensional tolerances to be expected.

Alternatively or additionally, the control variable that is input to the friction-gear drive 26—for instance, a speed of advance for the cart train 22 (comprising the load cross-member 14 and the passive running mechanisms 18), possibly converted into a rotational speed or rpm of the driving roller—can be compared with an actual speed of the cart train 22. A deviation possibly occurring, to the effect that the actual speed of the cart train lags behind the set speed of advance of the cart train by a certain absolute or relative amount, can be eliminated by a corresponding increase of the prestressing force. The actual speed of the cart train 22 can, for instance, be measured by appropriate sensors along the path of travel of the cart train. The adaptation of the prestressing force can, for instance, be undertaken dynamically during a conveying process.

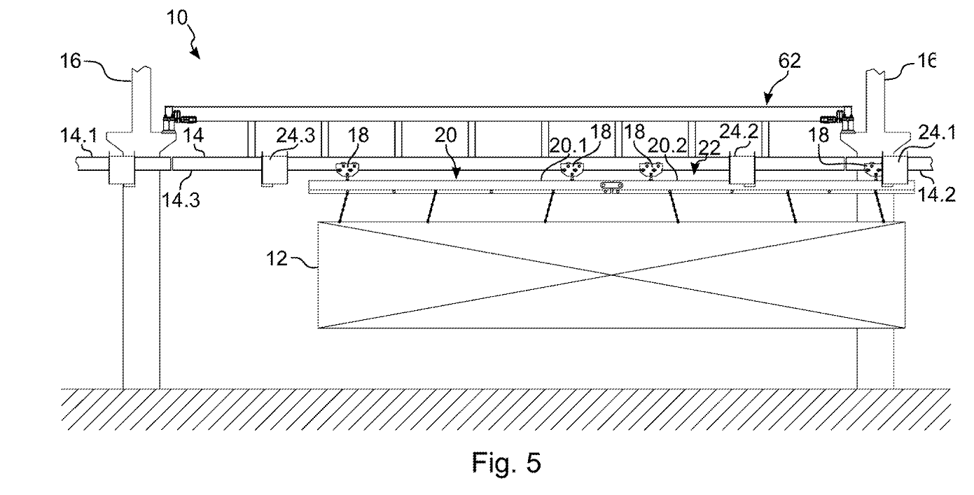

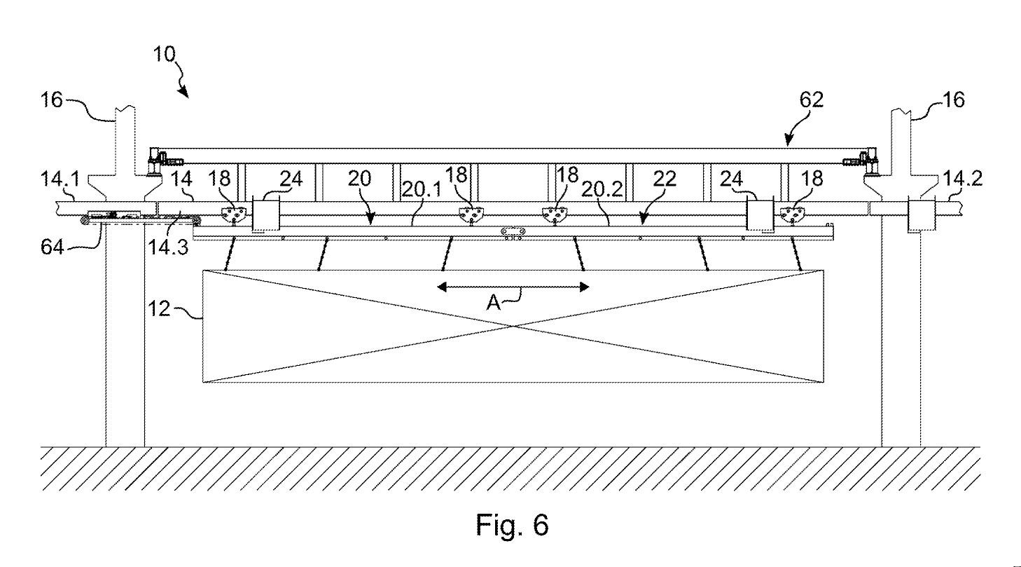

FIGS. 5 and 6 show various possible applications of the overhead conveyor 10. FIG. 5 illustrates a transfer of a cart train 22—assembled from a load cross-member 20 and passive running mechanisms 18 with an attached workpiece 12—to a traversing bridge 62 which is capable of being traversed perpendicular to the plane of the drawing by means of a stationary drive device 24.1 fastened to a stationary steel structure 16 and implemented as a friction-gear drive. The traversing bridge 62 likewise exhibits two drive devices 24.2, 24.3, by means of which the cart train 22 can be accepted and can be moved on the traversing bridge.

FIG. 6 illustrates a transfer of a cart train from a stationary transfer conveyor 64 to the traversing bridge 62.

What is claimed is:

1. An overhead conveyor for conveying heavy loads, comprising:
a) passive running mechanisms, guided on rails, for receiving a heavy load,
b) wherein at least two of the passive running mechanisms have been connected via a load cross-member to form a passive cart and
c) the load cross-member is designed to receive the heavy load, extends substantially along a conveying direction, is attached below the at least two of the passive running mechanisms, and
d) at least one stationary drive device for introducing a propelling force onto the passive cart,
e) wherein the at least one stationary drive device exhibits a friction-gear/mating-gear arrangement and also a contact-pressure appliance,
f) wherein for the purpose of transmitting the propelling forces to the load cross-member the friction gear is arranged on a first side of the load cross-member, and for the purpose of transmitting a transverse force to the load cross-member and/or for the purpose of receiving a transverse force from the load cross-member at right angles to the conveying direction the mating gear is arranged on a side situated opposite the first side of the load cross-member,
g) wherein a contact force is exerted in the direction of the load cross-member via the mating gear and/or via the friction gear by means of the contact-pressure appliance,
wherein
h) the at least one stationary drive device exhibits a prestressing device which is designed to impose an additional prestressing force on the contact-pressure appliance.

2. The overhead conveyor as claimed in claim 1, wherein the prestressing device is capable of being be triggered via hydraulic, electrical and/or pneumatic means.

3. The overhead conveyor as claimed in claim 1, wherein the prestressing device has been set up to compensate for a variable spacing between the load cross-member.

4. The overhead conveyor as claimed in claim 1, wherein the prestressing force imposed on the contact-pressure appliance has a component that acts in the direction of the contact force.

5. The overhead conveyor as claimed in claim 1, wherein the prestressing device is mounted so as to be fixed relative to the contact-pressure appliance.

6. The overhead conveyor as claimed in claim 1, wherein the prestressing device includes an eccentric.

7. The overhead conveyor as claimed in claim 1, wherein the mating gear is mounted so as to be capable of swiveling about a mating-gear swivel axis, said mating-gear swivel axis being oriented perpendicular to the extent of the load cross-member.

8. The overhead conveyor as claimed in claim 7, wherein the contact-pressure appliance is mounted so as to be capable of swiveling about a contact-pressure-appliance swivel axis, said contact-pressure-appliance swivel axis and said mating-gear swivel axis extending through a common point of rotation.

9. The overhead conveyor as claimed in claim 1, wherein the friction gear exhibits a friction-gear axis, and the at least one stationary drive device is designed to introduce a force onto the load cross-member substantially perpendicular to a longitudinal orientation of the load cross-member and substantially perpendicular to the friction-gear axis.

10. The overhead conveyor as claimed in claim 1, with at least two stationary drive devices, wherein the spacing between the at least two stationary drive devices corresponds at most to the length of a load cross-member.
